(19) United States
(12) Patent Application Publication
(10) Pub. No.: US 2013/0178768 A1
(43) Pub. Date: Jul. 11, 2013

(54) MASSAGE TOOLS

(71) Applicants: William Dalebout, North Logan, UT (US); Gaylen Ercanbrack, Logan, UT (US); Jaremy Butler, Herriman, UT (US)

(72) Inventors: William Dalebout, North Logan, UT (US); Gaylen Ercanbrack, Logan, UT (US); Jaremy Butler, Herriman, UT (US)

(73) Assignee: ICON HEALTH & FITNESS, INC., Logan, UT (US)

(21) Appl. No.: 13/545,883

(22) Filed: Jul. 10, 2012

Related U.S. Application Data
(60) Provisional application No. 61/506,794, filed on Jul. 12, 2011.

(51) Int. Cl. A61H 15/00; A61H 7/00

(52) U.S. Cl. CPC A61H 15/0092; A61H 7/00
USPC 601/46; 601/118

(57) ABSTRACT

A massage tool kit including a first massage tool comprising one or more grips and one or more rollers and a second massage tool having a bore extending at least partially therethrough with the bore being sized to selectively receive the first massage tool therein, and a third massage tool having a bore extending at least partially therethrough with the bore being sized to selectively receive the second massage tool therein.

### RELATED U.S. APPLICATIONS

This application claims priority from U.S. provisional application No. 61/506,794 filed on Jul. 12, 2011.

### TECHNICAL FIELD

This invention relates generally to systems, methods, and devices for massaging muscles. More particularly, the invention relates to kits, assemblies and combinations of massage tools.

### BACKGROUND

Many types of exercises lead to muscle stiffness, knots, and soreness. To help prevent or alleviate these conditions, muscles may be stretched or massaged. Nevertheless, exercisers may find it difficult to stretch or massage their muscles sufficiently. This may be due in part to the particular muscles affected, the location of the muscles, or the severity of the stiffness, knots, or soreness.

In order to avoid or relieve these conditions, tools have been developed to help exercisers stretch or massage their muscles. Such tools include foam rollers and a product called “The Stick.” These tools may be rolled over muscles to stretch the muscles or to relieve soreness, stiffness, and knots.

### SUMMARY OF THE INVENTION

In one aspect of the disclosure, a massage tool kit includes first, second, and third massage tools.

In another aspect that may be combined with any of the aspects herein, the first massage tool comprises one or more grips and one or more rollers.

In another aspect that may be combined with any of the aspects herein, the one or more rollers are rollable over a user's muscles.

In another aspect that may be combined with any of the aspects herein, the second massage tool has a bore extending at least partially therethrough.

In another aspect that may be combined with any of the aspects herein, the bore of the second massage tool is sized to selectively receive the first massage tool therein.

In another aspect that may be combined with any of the aspects herein, the second massage tool is rollable over a user's muscles.

In another aspect that may be combined with any of the aspects herein, the third massage tool has a bore extending at least partially therethrough.

In another aspect that may be combined with any of the aspects herein, the bore of the third massage tool is sized to selectively receive the second massage tool therein.

In another aspect that may be combined with any of the aspects herein, the third massage tool is rollable over a user's muscles.

In another aspect that may be combined with any of the aspects herein, the first massage tool comprises a bar upon which the one or more rollers are mounted.

In another aspect that may be combined with any of the aspects herein, the one or more rollers are rotatably mounted on the bar.

In another aspect that may be combined with any of the aspects herein, the one or more rollers are fixedly mounted on the bar.

In another aspect that may be combined with any of the aspects herein, the first massage tool comprises a vibration mechanism.

In another aspect that may be combined with any of the aspects herein, the vibration mechanism comprises an eccentric weight rotatably disposed within the first massage tool.

In another aspect that may be combined with any of the aspects herein, the second massage tool is generally cylindrical in shape.

In another aspect that may be combined with any of the aspects herein, the second massage tool comprises contours formed on an outer surface thereof.

In another aspect that may be combined with any of the aspects herein, the contours comprise at least one of ridges, valleys, dimples, bumps or combinations thereof.

In another aspect that may be combined with any of the aspects herein, the bore in the second massage tool and an outer surface of the first massage tool create an interference fit when the first massage tool is received within the bore of the second massage tool.

In another aspect that may be combined with any of the aspects herein, the second massage tool is formed of a substantially rigid material.

In another aspect that may be combined with any of the aspects herein, the third massage tool comprises an inner support cylinder and an outer cushion disposed on the inner support cylinder.

In another aspect that may be combined with any of the aspects herein, the inner support cylinder is formed of a substantially rigid material.

In another aspect that may be combined with any of the aspects herein, the outer cushion is formed of a relatively soft material.

In another aspect that may be combined with any of the aspects herein, the massage tool kit also includes a strap connected to one of the first, second, or third massage tools.

In another aspect that may be combined with any of the aspects herein, the first massage tool comprise a bar and one or more rollers mounted on the bar, the one or more rollers being rollable over a user's muscles.

In another aspect that may be combined with any of the aspects herein, a vibration mechanism is disposed within one of the first, second, or third massage tools.

In another aspect that may be combined with any of the aspects herein, the vibration mechanism comprises an eccentric weight rotatably disposed within the massage tool.

In another aspect that may be combined with any of the aspects herein, the vibration mechanism comprises one or more motors that rotate the eccentric weight.

In another aspect that may be combined with any of the aspects herein, the massage tool kit further comprises a power cable that selectively connects the vibration mechanism to a power source.

In another aspect that may be combined with any of the aspects herein, one or more grips are mounted on the bar of the first massage tool.

In another aspect that may be combined with any of the aspects herein, the second massage tool has contours formed on an outer surface thereof.

In another aspect that may be combined with any of the aspects herein, the third massage tool includes an inner support cylinder.

In another aspect that may be combined with any of the aspects herein, the inner support cylinder is formed of a substantially rigid material.

In another aspect that may be combined with any of the aspects herein, the inner support cylinder has a bore extending at least partially therethrough, the bore being sized to selectively receive the second massage tool therein with a friction fit therebetween.

In another aspect that may be combined with any of the aspects herein, the third massage tool includes an outer cushion disposed on the inner support cylinder, the outer cushioning being formed of a relatively soft material and having contours formed on an outer surface thereof.

In another aspect that may be combined with any of the aspects herein, the contours formed on the outer surfaces of the second massage tool and the outer cushion of the third massage tool comprise at least one of ridges, valleys, dimples, bumps or combinations thereof arranged in regular or irregular patterns.

### BRIEF DESCRIPTION OF THE DRAWINGS

FIG. 1 illustrates an exemplary massage kit according to the present invention.

FIG. 2 illustrated an exploded view of the massage kit of FIG. 1.

FIG. 3 illustrates a cross-sectional view of the massage kit of FIG. 1.

FIG. 4 illustrates another exemplary massage kit according to the present invention.

### DETAILED DESCRIPTION

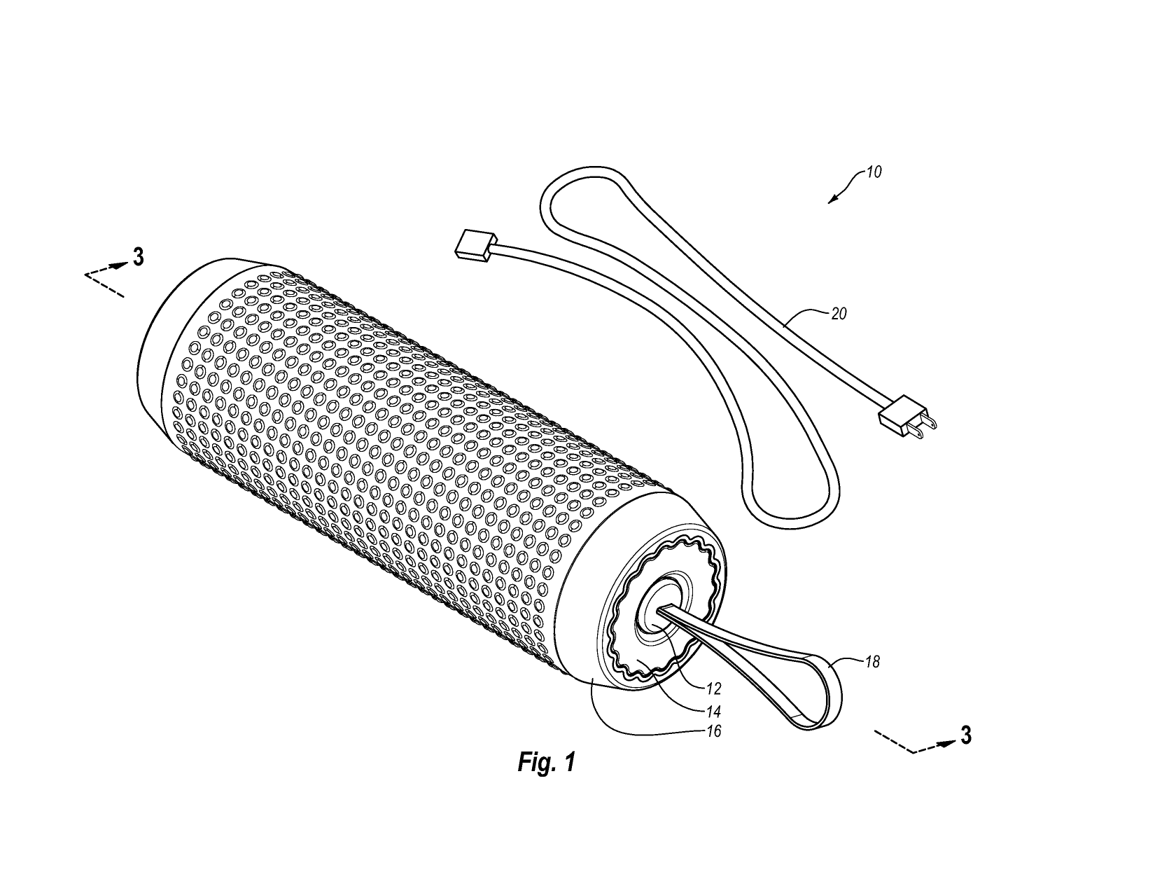

The present invention is directed to massaging tools, and particularly to combinations, kits, or assemblies of multiple massaging tools. FIG. 1 illustrates an exemplary embodiment of a massage kit 10. In the illustrated embodiment, massage kit 10 includes three massage tools 12, 14, 16, but may also include two or more than three tools. Each of tools 12, 14, 16 may be used to stretch muscles or relieve muscle ailments. Massage kit 10 also includes a strap 18 connected to at least one of tools 12, 14, 16 that may be used to pick up or carry kit 10. A power cable 20 is also provided for recharging a battery that may be disposed within one of tools 12, 14, 16, as discussed below.

As can be seen in FIG. 1, tools 12, 14, 16 can be assembled substantially inside one another to form a relative compact unit that may be easily stored or transported. Furthermore, tools 12, 14, 16 may be designed to remain assembled as shown until a user removes tool 12 or tool 14. In other words, tool 14 may be designed to remain positioned within tool 16 until a user actively removes tool 14 from tool 16. Likewise, tool 12 may be designed to remain positioned within tool 14 until a user actively removes tool 12 from tool 14. Interference fits may be used between tool 12 and tool 14 and between tool 14 and tool 16 to maintain the assembled configuration of kit 10, as shown in FIG. 1. Additionally, or alternatively, kit 10 may include one or more retaining straps or the like that may be used to selectively hold tools 12, 14, 16 in the assembled configuration shown. Similarly, kit 10 may include a bag or other container into which tools 12, 14, 16, in the assembled configuration, may be placed to prevent tools 12, 14, 16 from becoming separated.

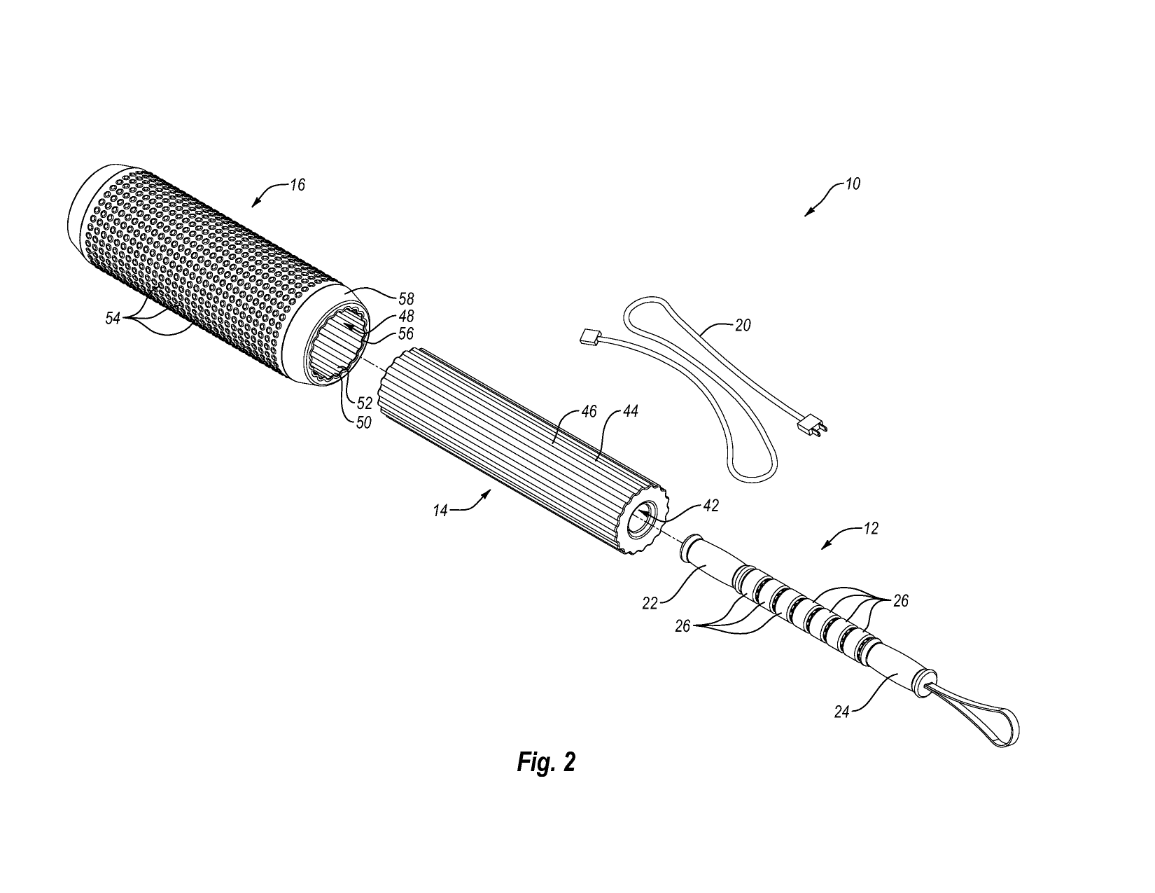

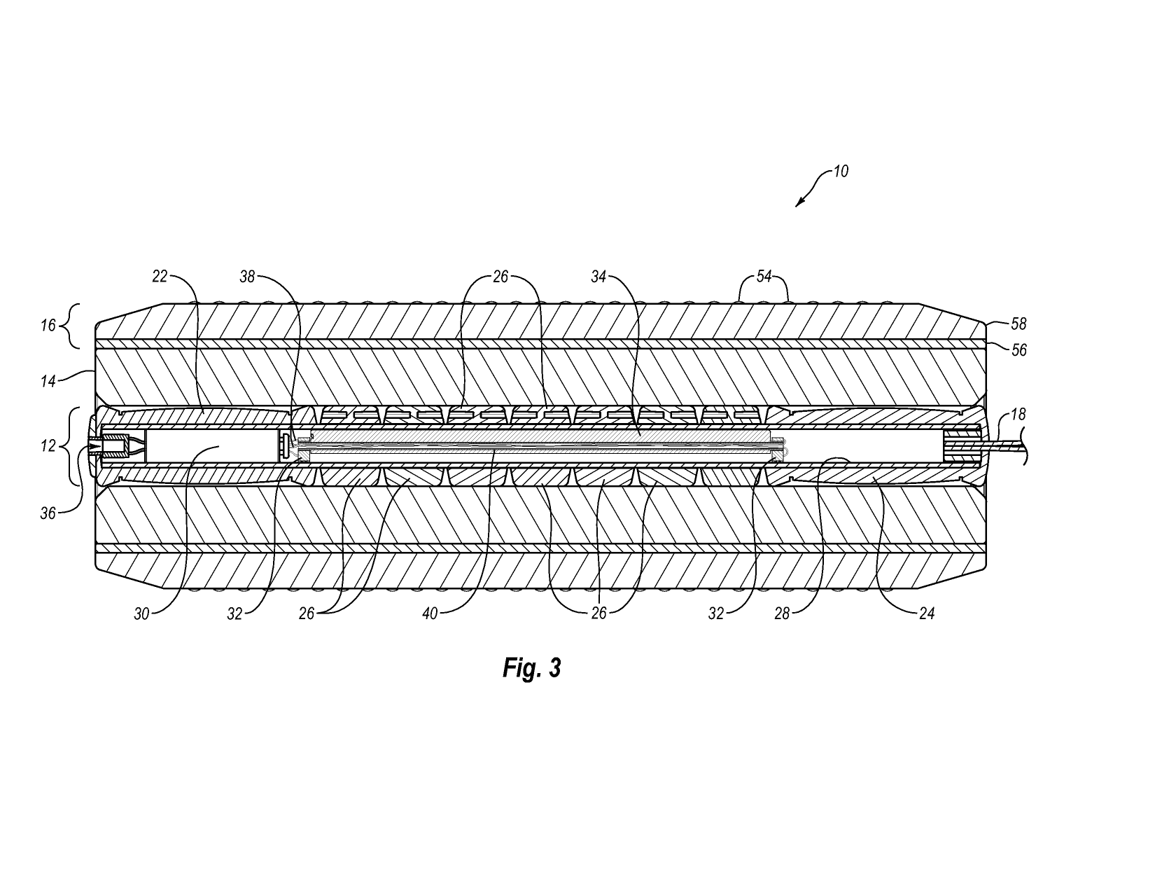

With attention to FIGS. 2 and 3, each of tools 12, 14, 16 will be discussed in greater detail. Tool 12 includes handles or grips 22, 24 and a plurality of rollers 26 disposed therebetween. As can be seen in FIG. 3, grips 22, 24 and rollers 26 are mounted or disposed on bar 28. In one embodiment, grips 22, 24 are fixedly mounted on bar 28 to prevent relative movement between grips 22, 24 and bar 28, while rollers 26 are rotatably mounted on bar 28 to allow for rollers 26 to rotate about and relative to bar 28. In another embodiment, grips 22, 24 are rotatably mounted on bar 28 to allow for grips 22, 24 to rotate about and relative to bar 28, while rollers 26 are fixedly mounted on bar 28 to prevent relative movement between rollers 26 and bar 28. In still other embodiments, grips 22, 24 and rollers 26 may all be fixedly or rotatably mounted on bar 28. In yet other embodiments, grips 22, 24 are integrally formed with bar 28 or are portions of bar 28.

In any case, a user may grasp one or both of grips 22, 24 and press rollers 26 against a muscle that needles to be stretched or massaged. As the user presses rollers 26 against the muscle, tool 12 may roll over the muscle. That is, rollers 26 or grips 22, 24 may rotate about bar 28 as the user moves tool 12 back and forth over the muscle. Rolling tool 12 over the muscle may stretch the muscle in preparation for exercise or may work knots, stiffness, or soreness out of the muscle.

As can be seen in the cross-sectional view of FIG. 3, tool 12 may optionally include a mechanism for vibrating tool 12 (and optionally tools 14, 16 when disposed around tool 12). The vibrating mechanism shown in FIG. 3 is disposed within bar 28 and includes a battery 30, one or more motors 32, and an eccentric weight 34. It will be understood by one of ordinary skill in the art that a vibration mechanism may include additional or different components from those illustrated in FIG. 3 to create a desired vibration.

In the illustrated embodiment, battery 30 is disposed within a first end of bar 28. Battery 30 may be any number of different types of batteries. For example, battery 30 may be a lithium-ion battery, an alkaline battery, or another type of battery. Battery 30 may also be rechargeable. In order to recharge battery 30, battery 30 may be removed from tool 12 and connected to an external recharging device. Alternatively, battery 30 may be configured to be recharged while remaining within tool 12. For example, battery 30 may be in electric communication with a charging port 36. Power cable 20 may be selectively connected to charging port 36 and a power source to recharge battery 30. In other embodiments, battery 30 may not be rechargeable. In embodiments where battery 30 is not rechargeable, tool 12 may be configured to allow batter 30 to be removed and replaced with a new batter.

In the illustrated embodiment, the one or more motors 32 are mounted within bar 28 and are electrically connected to battery 30 by way of wires 38. A support bar 40 is supported by the one or more motors 32. While support bar 40 is shown as being generally coaxial with a central longitudinal axis of tool 12, support bar 40 does not have to be coaxial with the central longitudinal axis of tool 12. Eccentric weight 34 is rotatably mounted on support bar 40. When motors 32 are powered by battery 30, motors 32 rotate eccentric weight 34 about support bar 40. The rotation of eccentric weight 34 causes tool 12 to vibrate. The vibration of tool 12 may assist in stretching or massaging muscles.

It is understood that various modifications may be made to the illustrated vibration mechanism. For instance, a single motor 32 may be used to rotate eccentric weight 34. Additionally, multiple eccentric weights 34 may be included. The multiple eccentric weights may be rotated by the same or different motors 32. Furthermore, the multiple eccentric weights 34 may be configured to rotate in the same or opposite directions from one another or in synch or out of synch with one another.

While the present embodiment of tool 12 is illustrated with two grips 22, 24 mounted on opposing ends of bar 28 and a plurality of rollers 26 disposed therebetween, other configurations are contemplated within the scope of the present invention. For instance, the plurality of rollers 26 may be replaced with a single roller. Likewise, a single grip or more than two grips may be included. For example, a single grip may be positioned on an end of bar 28 similar to one of grips 22, 24, while the other grip is omitted. Alternatively, a single grip may be mounted near the center, or at another place along the length of bar 28, and rollers 26 may be positioned on opposing sides of the single grip. Still further, three or more grips may be included, such as two grips on opposing ends of bar 28 and a single grip positioned near the center of bar 28. In such an embodiment, rollers may be positioned between the three grips.

Attention is now directed to tool 14. As can be seen in FIG. 2, tool 14 has a generally cylindrical shape with a bore 42 extending therethrough. Bore 42 may be sized and shaped to receive tool 12 therein as shown in FIGS. 1 and 3. Furthermore, bore 42 and tool 12 may be sized and shaped to create a friction or interference fit so that tool 12 may be selectively retained within bore 42 when tool 12 is not in use.

Similar to tool 12, tool 14 may be used to stretch or massage muscles. More specifically, tool 14 may be rolled over muscles to stretch or massage the muscles. In addition to holding tool 14 while rolling it over muscles, tool 14 may be placed on the floor, ground, or other support surface, and the user may rest on tool 14. While resting on tool 14, the user may move back and forth so that tool 14 rolls underneath the user. The rolling of tool 14 underneath the user can stretch or massage the user's muscles under which tool 14 is rolling. When used in this manner, the weight of the user's body can assist in applying greater pressure to the muscles, which may help work out tight knots and the like.

The outer circumferential surface of tool 14 may be generally smooth or, as illustrated in FIG. 2, may include contours. As is understood, the contours may assist with the massaging of muscles. The illustrated contours include alternating ridges 44 and valleys 46 that extend between opposing ends of tool 14 and are generally parallel to a longitudinal axis of tool 14. Nevertheless, the contours may take any number of different forms. For instance, the contours may include ridges and valleys that extend circumferentially or helically about the outer surface of tool 14. In other embodiments, the contours may include dimples, bumps, or any combination of different contours, whether in regular or irregular patterns.

Tool 14 may be formed of any suitable material. For instance, tool 14 may be formed of a generally rigid material, such as plastic, metal, wood, ceramic, and the like. Forming tool 14 with rigid material may be useful for massaging certain muscles or to alleviate certain muscle ailments. Alternatively, tool 14 may be formed of a less rigid material, such as rubber, foam, and the like. Forming tool 14 from a softer material may likewise be useful in massaging certain muscles or alleviating certain muscle ailments. Furthermore, tool 14 may be formed with a relatively rigid core material that has a softer material disposed therearound.

Attention is now directed to tool 16. Similar to tools 12, 14, tool 16 may be used to stretch or massage muscles. More specifically, tool 16 may be rolled over muscles to stretch or massage the muscles. Like tool 14, tool 16 may be held while rolling it over muscles or tool 16 may be placed on the floor, ground, or other support surface, and the user may rest on tool 16. The user may move back and forth so that tool 16 rolls underneath the user to stretch or massage the user's muscles under which tool 16 is rolling. As mentioned above, when used in this manner, the weight of the user's body can assist in applying greater pressure to the muscles, which may help work out tight knots and the like.

As can be seen in FIG. 2, tool 16 has a generally cylindrical shape with a bore 48 extending therethrough. Bore 48 may be sized and shaped to receive tool 14 therein as shown in FIGS. 1 and 3. Furthermore, bore 48 and tool 14 may be sized and shaped to create a friction or interference fit so that tool 14 may be selectively retained within bore 48 when tool 14 is not in use. For instance, bore 48 and tool 14 may have corresponding diameters that create the friction fit when tool 14 is inserted into bore 48. In addition, the interior surface of bore 48 may include contours that correspond to or interact with the contours on tool 14. In the illustrated embodiment, for example, the interior surface of bore 48 includes valleys 50 and peaks 52 that correspond to or mate with peaks 44 and valleys 46 of tool 14 when tool 14 is received within bore 48.

The outer circumferential surface of tool 16 may be generally smooth or, as illustrated in FIGS. 1-3, may include contours. As is understood, the contours may assist with the massaging of muscles. The illustrated contours include an array of bumps 54 on the outer surface of tool 16. Nevertheless, the contours may take any number of different forms. For instance, the contours may include bumps, ridges, valleys, dimples, or any combination of different contours, whether in regular or irregular patterns.

Tool 16 may be formed of any suitable manner. In the illustrated embodiment, tool 16 includes an internal support cylinder 56 and an outer cushion 58. Internal support cylinder 56 is formed of a generally rigid material. Forming support cylinder 56 of a generally rigid material allows tools 16 to support a user thereon while tool 16 retains its generally cylindrical shape. Support cylinder 56 has bore 48 formed therein. Outer cushion 58 is disposed around support cylinder 56 to provide some cushioning to the user has the user moves back and forth on tool 16. Bumps 54 or other contours are formed on the outer surface of outer cushion 58. Outer cushion 58 may be permanently disposed around support cylinder 56 or may be selectively removable therefrom.

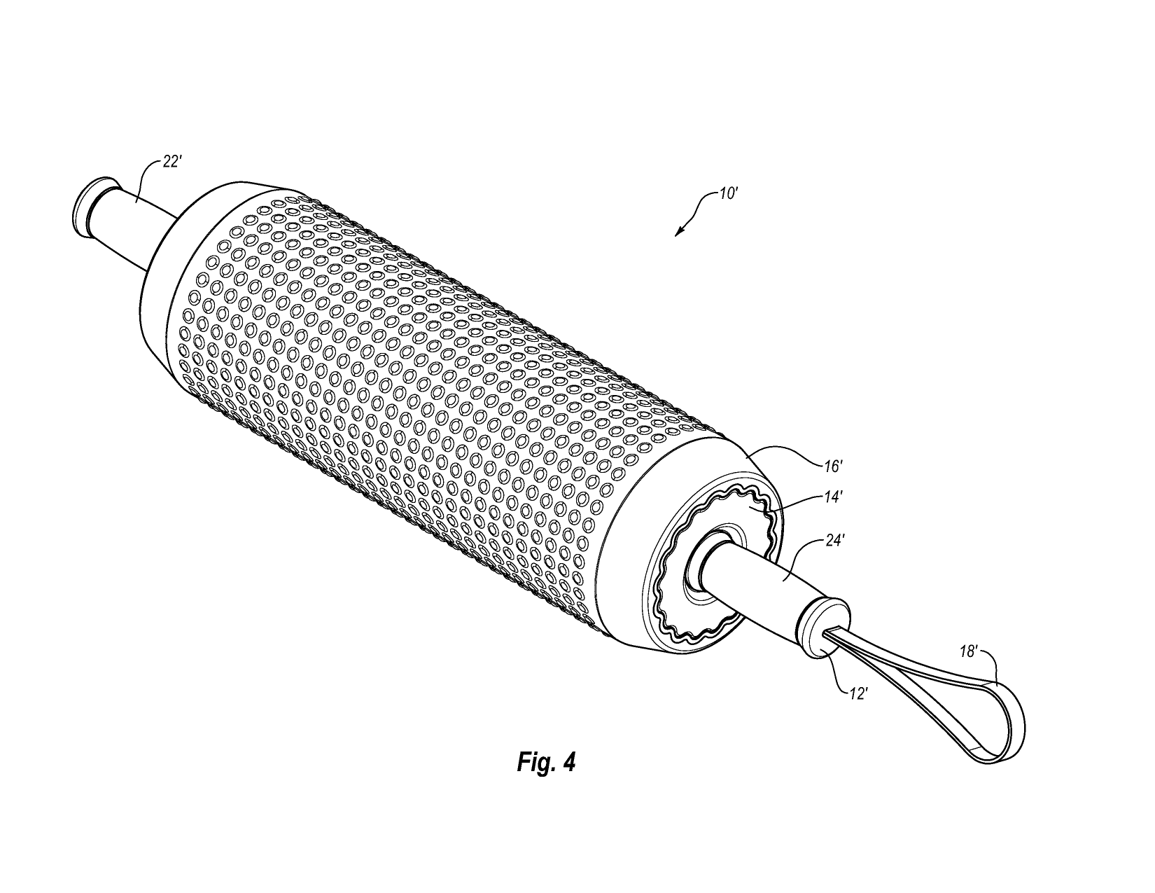

Attention is now directed to FIG. 4, which illustrates an alternative embodiment of a massage kit according to the present invention. Massage kit 10′, as illustrated in FIG. 4, is similar or identical in many respect to massage kit 10 described above. For instance, massage kit 10′ includes three massage tools 12′, 14′, 16′. In the illustrated embodiment, tools 14′, 16′ are the identical to massage tools 14, 16 described above. Unlike massage kit 10, however, grips 22′, 24′ of tool 12′ extend out of the ends of tools 14′, 16′ as shown in FIG. 4. Exposing grips 22′, 24′ enables a user to hold grips 22′, 24′ while rolling tool 14 or tool 16 over a muscle. Exposure of grips 22′, 24′ may be accomplished by increasing the length of tool 12′, decreasing the lengths of tools 14′, 16′, or a combination thereof. While not illustrated in FIG. 4, kit 10′ may optionally include a vibration mechanism and a power cable similar to the one described above.

### INDUSTRIAL APPLICABILITY

In general, embodiments of the present disclosure relate to massage tool kits that can be used to stretch muscles or relieve muscle ailments. The kits may include two or more massage tools. One of the massage tools may include one or more grips and one or more rollers that are mounted on a bar. The rollers or grips may be rotatably mounted on the bar to facilitate rolling of the tool over the user's muscles. Other tools from the kit may be designed to have a user rest thereon while the user moves back and forth on the tool. The back and forth movement by the user causes the tool to roll underneath the user, thereby massaging the user's muscles.

Each of the tools in the kit may be formed of relatively rigid materials, less rigid or softer materials, or combinations thereof. The different materials may be useful for massaging certain muscles or relieving certain muscles ailments. Similarly, the surfaces of the tools may include contours that assist in the massaging of muscles.

The kit may optionally include a vibration mechanism. Vibrations can assist with stretching muscles or relieving muscles ailments, such a knots, soreness, and stiffness. The vibration mechanism may take any suitable form, including an eccentric weight that is rotated within one of the tools.

The various tools of the kit may be assembled in a compact manner to facilitate transportation or storage of the kit. In other words, rather than having to keep track of, carry, and store several different tools, the tools of the present invention can be assembled together so that the various tools can be carried and stored as a singled unit. For instance, some of the tools may include bores extending at least partially therethrough which are sized to receive other of the tools therein. For instance, in a kit with three tools, the smallest tool may be received within a bore of the next smallest tool. Furthermore, the second smallest tool may be received within a bore of the largest tool. The tools may be assembled in this manner so that the various tools remain disposed within one another until a user actively removes the tools from one another.

What is claimed is:

1. A massage tool kit, comprising:
a first massage tool comprising one or more grips and one or more rollers;
a second massage tool having a bore extending at least partially therethrough, the bore being sized to selectively receive the first massage tool therein; and
a third massage tool having a bore extending at least partially therethrough, the bore being sized to selectively receive the second massage tool therein.

2. The massage tool kit of claim 1, wherein the first massage tool comprises a bar upon which the one or more rollers are mounted.

3. The massage tool kit of claim 1, wherein the one or more rollers are formed of a substantially rigid material and the second and third massage tools are each formed of a relatively soft material.

4. The massage tool kit of claim 2, wherein the one or more rollers are fixedly mounted on the bar.

5. The massage tool kit of claim 1, wherein the first massage tool comprises a vibration mechanism.

6. The massage tool kit of claim 6, wherein the vibration mechanism comprises an eccentric weight rotatably disposed within the first massage tool.

7. The massage tool kit of claim 1, wherein the second massage tool is generally cylindrical in shape.

8. The massage tool kit of claim 1, wherein the second massage tool comprises contours formed on an outer surface thereof.

9. The massage tool kit of claim 8, wherein the contours comprise at least one of ridges, valleys, dimples, bumps or combinations thereof.

10. The massage tool kit of claim 1, wherein the bore in the second massage tool and an outer surface of the first massage tool create an interference fit when the first massage tool is received within the bore of the second massage tool.

11. The massage tool kit of claim 1, wherein the second massage tool is formed of a substantially rigid material.

12. The massage tool kit of claim 1, wherein the third massage tool comprises an inner support cylinder and an outer cushion disposed on the inner support cylinder.

13. The massage tool kit of claim 12, wherein the inner support cylinder is formed of a substantially rigid material.

14. The massage tool kit of claim 12, wherein the outer cushion is formed of a relatively soft material.

15. The massage tool kit of claim 1, further comprising a strap connected to one of the first, second, or third massage tools.

16. A massage tool kit, comprising:
a first massage tool comprising a bar and one or more rollers mounted on the bar;
a second massage tool having a bore extending at least partially therethrough, the bore being sized to selectively receive the first massage tool therein;
a third massage tool having a bore extending at least partially therethrough, the bore being sized to selectively receive the second massage tool therein; and
a vibration mechanism disposed within one of the first, second, or third massage tools, the vibration mechanism comprising an eccentric weight rotatably disposed within the massage tool.

17. The massage tool kit of claim 16, wherein the vibration mechanism comprises one or more motors that rotate the eccentric weight.

18. The massage tool kit of claim 16, further comprising a power cable that selectively connects the vibration mechanism to a power source.

19. A massage tool kit, comprising:
a first massage tool comprising;
a bar;
one or more rollers rotatably mounted on the bar; and
one or more grips mounted on the bars
a second massage tool having a generally cylindrical shape and a bore extending at least partially therethrough, the bore being sized to selectively receive the first massage tool therein with a friction fit therebetween, the second massage tool having contours formed on an outer surface thereof; and
a third massage tool comprising:
an inner support cylinder formed of a substantially rigid material and having a bore extending at least partially therethrough, the bore being sized to selectively receive the second massage tool therein with a friction fit therebetween; and
an outer cushion disposed on the inner support cylinder, the outer cushioning being formed of a relatively soft material and having contours formed on an outer surface thereof.

20. The massage tool kit of claim 19, wherein the contours formed on the outer surfaces of the second massage tool and the outer cushion of the third massage tool comprise at least one of ridges, valleys, dimples, bumps or combinations thereof arranged in regular or irregular patterns.
